(19) United States
(12) Patent Application Publication
(10) Pub. No.: US 2007/0215295 A1
(43) Pub. Date: Sep. 20, 2007

(54) SECTIONAL DOOR

(75) Inventors: Thomas J. Hormann, St. Wendel (DE); Michael Brinkmann, Halle (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: HORMANN KG BROCKHAGEN, Steinhagen (DE)

(21) Appl. No.: 11/686,163

(22) Filed: Mar. 14, 2007

(30) Foreign Application Priority Data
Mar. 16, 2006 (DE) 102006012224.0

(51) Int. Cl. E06B 3/12

(52) U.S. Cl. 160/236

(57) ABSTRACT

Embodiments of the present invention provide a sectional door with a door leaf movable longitudinally along a preset path between a closed and an open position, with said door leaf having a shell-like or single-wall design, with a shell bottom forming an outer boundary surface of the door leaf, and two shell edges preferably extending over the entire door leaf width in the direction of the articulating axes and protruding from the shell bottom in the direction of the space closed off thereby, with one of the shell edges having a hollow protrusion extending over the entire width of the door leaf and the other shell edge comprising a recess designed to accommodate a protrusion of an adjacent door leaf element, and with an insulating element, being inserted into the shell-like door leaf element, with the insulating element having a flange capable of being inserted into the hollow protrusion of the door leaf element and/or an edge profile on or in an edge of an insulating element, with said edge profile being designed to accommodate at least a part of the recess of the door leaf element which extends in the thickness direction of the door leaf element.

### CROSS REFERENCE TO RELATED APPLICATIONS

The present application claims International Priority under 35 U.S.C. § 119 to co-pending German Patent Application No. 102006012224.0, filed Mar. 16, 2006, entitled “Sektionaltor,” the entire disclosure of which is hereby incorporated by reference in its entirety.

### TECHNICAL FIELD

Embodiments of the present invention relate to sectional doors. More particularly, various embodiments relate to techniques for insulating sectional doors without excessive engineering and/or assembly-related technical effort.

### BACKGROUND

Sectional doors are used as garage doors or industrial doors to provide a closure of a pathway or passage and are distinguished from other doors in that the sectional door leaf does not pivot out into the space to be closed by it during an opening and closing movement. This is accomplished by each door leaf of a sectional door being movable longitudinally along a path preset by a guide rail arrangement between a closed position, in which the sectional door is essentially arranged in a vertical plane, and an open position, in which the sectional door is generally arranged overhead in a horizontal plane. A sectional door consists of a multitude of door leaf elements arranged in succession longitudinally along the present path, with these door leaf elements being connected by means of joints exhibiting articulating axes extending perpendicular to the preset path.

With simple sectional doors, it is possible that an opening may form during a pivot movement of individual door leaf elements, allowing a finger to be inserted, which poses the risk of finger pinching in the course of the door leaf movement when the opening closes again. These problems can be solved by providing a protrusion on the upper edge of the door leaf elements, which is pivotable with respect to the articulated axis in the course of a pivot movement within a recess provided at the lower edge of an adjacent panel, to avoid creating an opening posing the risk of finger pinching. Sectional door designs of this type are described in e.g., EP-A-304 642 and EP-A-370 376, the entire disclosures of which are hereby incorporated by reference in their entirety with respect to the design of the door leaf elements.

In addition to the general purpose of sectional doors to provide a burglar-proof closure of a pathway or passage, sectional doors are also usually intended to provide a thermal or acoustic separation of spaces closed by them from the environment. For this purpose, the above-named patent specifications propose double-shell door leaf elements in which a foam core is formed between an outer metal shell forming the outer door leaf boundary surface and an inner metal shell of the door leaf element forming the inner boundary surface of the door leaf.

Such door leaf elements are produced by introducing a self-foaming material, such as e.g. polyurethane, into the outer shell and subsequently closing the outer shell by means of the inner shell in order to limit the foaming process. The self-foaming material will then fill up the entire internal space of the double-shell door leaf element.

However, the manufacture of such double-shell door leaf elements is especially costly because not only do two metal shells have to be provided, but the individual manufacturing steps also have to be carefully coordinated in order to ensure that, on the one hand, the entire interior space of the door leaf element is filled up by the foam and, on the other hand, the foam is prevented from exiting the door leaf element.

In view of these difficulties, single-shell door leaf elements are also provided with additional insulating elements for insulating purposes using a metal shell, of the type described above, and open in the direction of the interior space of the open metal shell. These additional insulating elements are usually cuboid insulating boards made of polystyrene which are glued onto the inner boundary surface of the shell bottom facing the interior of the space to be closed off by the door leaf.

Unfortunately the manufacture of such single-shell door leaf elements with additional insulating elements requires considerable time and effort and does not provide a satisfactory insulating effect.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIGS. 1a, 1b, 1c, and 1d are schematic representations of door leaf elements suitable for use in the manufacture of a sectional door in a plane that is perpendicular to the articulating axes in accordance with various embodiments of the present invention; and

FIGS. 2a, 2b, and 2c illustrate the assembly of sectional doors in accordance with various embodiments of the present invention.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide sectional doors that provide a satisfactory insulating effect while avoiding an excessive design-engineering and/or assembly-related technical effort.

Embodiments of the invention relate to sectional doors each having a door leaf that is longitudinally movable along a preset path between a closed position and an open position. In an embodiment, each door leaf of the sectional door exhibits a multitude of door leaf elements pin jointed with respect to articulating axes extending perpendicular to the preset path. In an embodiment, a shell-like or single-wall design may be used, particularly in the form of a cold-formed metal shell. A shell bottom forms an outer boundary surface of the door leaf. Two shell edges, preferably extending over the entire width of the door leaf in the direction of the articulating axes, protrude from the shell bottom in the direction of the space closed by the sectional door. One of the shell edges exhibits a hollow protrusion preferably extending over the entire width of the door leaf and projects upwards, especially in the closed position. The other shell edge includes a recess designed to accommodate a protrusion of an adjacent door leaf element. An insulating element, particularly an insulating board made of polystyrene, may be inserted into the shell-like door leaf.

In accordance with various embodiments of the invention, there is provided a sectional door including an insulating element and a flange insertable into a protrusion of the door leaf element and preferably extending over the entire width of the insulating element and/or an edge profile designed to accommodate at least one portion of the recess of the door leaf element extending in the direction of the thickness of the door leaf element, or to accommodate a respective recess on or in an edge of an insulating element.

In accordance with embodiments of the invention, an insulating element may be inserted with a positive locking relationship into the door leaf element shell which is open in the direction of the space to be closed off by the door leaf. In this way, a simplification of the assembly of sectional doors in accordance with an embodiment of the invention is achieved because the adhesive attachment of the insulating elements to the door leaf elements is no longer necessary. In addition, the filling-in of the protrusion by the flange of the insulating element accommodated therein or the accommodation of the recess of the door leaf element in the notch or recess in the edge of the insulating element produces an improvement of the insulating effect because the sectional doors in accordance with embodiments of the invention allow one to achieve an insulating effect along the entire height of the door leaf element in a direction extending parallel to the preset path.

In an embodiment, door leaf elements with single-shell design exhibit a cassette-like and/or beaded (grooved) profile in the shell bottom for stabilization purposes which can also protrude in the direction of the space closed off by the door leaf. In order to avoid arching of the insulating element accommodated in the single-shell door leaf element using this profile, the insulating element exhibits a recess designed to accommodate the profile in its boundary surface facing the shell bottom. To simplify the manufacture of insulating elements which can be used for the manufacture of sectional doors in accordance with an embodiment of the invention, this recess may extend, irrespective of the form of the profile, over the entire width of the insulating element in the direction of the articulating axes. A precise adjustment of the recess to the profile is not mandatory in order to ensure the desired insulating effect. This significantly simplifies the manufacture of sectional doors in accordance with the invention, in particular when door leaf elements with cassette-like profiles are used. A further simplification of the manufacturing process can be achieved by giving the bottom of the recess formed in the insulating element a flat design. Overall, the recess in the boundary surface of the insulating element facing the shell bottom can also be designed in the form of a single flat bead (groove) with a rectangular cross section.

In the manufacture of sectional doors in accordance with an embodiment of the invention, the insulating element may be inserted at the factory or retroactively into the door leaf element. For this purpose, the insulating element has to be slightly bent around a bending axis extending parallel to the articulating axes in order for the flange of the insulating element to be capable of being guided into the hollow protrusion of the door leaf element and/or the notch of the insulating element via the recess of the door leaf element. This process may be facilitated while avoiding damage to the insulating element by having the insulating element exhibit a weak area facilitating the bending around a bending axis extending parallel to the articulating axes. This weak area may be created, for example, by making the insulating element partially from a material with low bending strength. However, from the point of view of manufacturing engineering, it has proven to be particularly advantageous if the insulating element exhibits at least one, preferably two, three or more slot(s) in the boundary surface facing the shell bottom and extending approximately in the direction of the articulating axes, because in this way the weak area may be realized using different types of materials for the insulating element. In this context, it was realized within the context of the invention, that the impairment of the insulating effect produced by the slots in the insulating element is hardly of any consequence and can be accepted without any problems in view of the advantages attainable thereby.

In an embodiment of the invention, the weak area is arranged in the recess accommodating the profile of the shell bottom.

An insulating element in accordance with an embodiment of the invention and suitable for the manufacture of sectional doors exhibits, at an edge extending parallel to the articulating axes of the sectional door, a flange capable of being inserted into a hollow protrusion of the door leaf element and preferably extending over the entire width of the insulating element, and/or a notch or recess on or in an insulating element, designed to accommodate the recess of the door leaf element, with an outer boundary surface of the insulating element facing the shell bottom of the door leaf element optionally having a recess designed to accommodate a profile of the shell bottom and/or a weak area facilitating the bending of the insulating element around a bending axis extending parallel to the articulated axes. The weak area may be realized at least by one, preferably two, three or more boundary surfaces of the insulating element in accordance with the invention, extending in the direction of the articulating axes and facing the shell bottom.

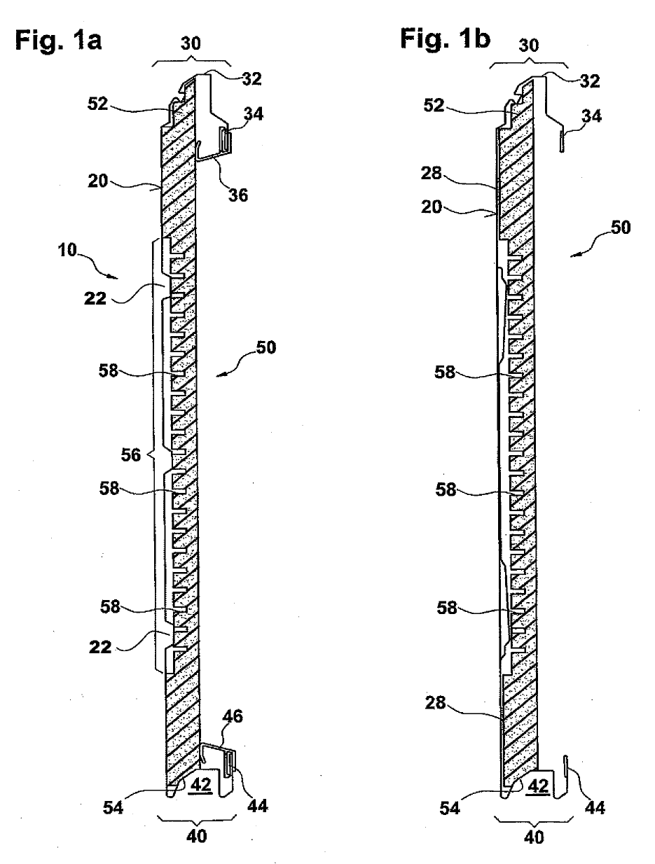

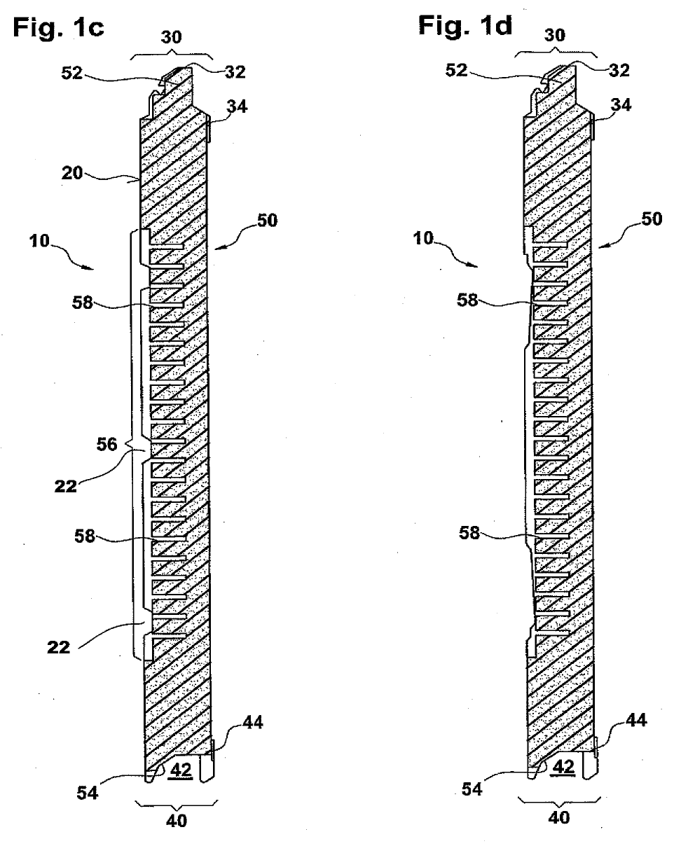

The door leaf elements shown in FIG. 1 essentially consist of a metal shell 10 and an insulating element 50. The metal shell 10 comprises a shell bottom 20 forming the outer boundary surface of the door leaf, an upper shell edge 30 protruding from the upper edge of the shell bottom 20 in the direction of the interior space to be closed off by the door leaf and extending over the entire width of the door leaf element in a direction running parallel to the articulating axes, as well as a lower shell edge 40 protruding from the bottom edge of the shell bottom 20 in the direction of the interior space to be closed by the door leaf.

The upper shell edge 30 comprises a protrusion 32 extending upwards and which is folded back onto itself at its edge area 34 facing away from the shell bottom 20 to form a reinforced area of accommodation for the fastening of screws serving as hinge tabs, as indicated at 34.

The bottom shell edge 40 comprises a recess 42 which is also folded back onto itself at the edge 44 facing away from the shell bottom. The form of the recess 42 corresponds essentially to the form of the protrusion 32 so that a protrusion accommodated in the recess 42 of an adjacent door leaf element may be pivoted, while avoiding the formation of an opening posing the risk of finger pinching, within the recess 42 with respect to a pivot axis running perpendicular to the paper plane in FIG. 1.

The shell bottom 20 comprises a stabilizing profile to ensure the stability of the door leaf element. As in the embodiments of the invention shown in FIGS. 1(a) and 1(c), this profile is designed using a multitude of beads (grooves) 22 extending parallel to the articulating axes or perpendicular to the paper plane in FIG. 1, with the beads exhibiting a rectangular cross section in the embodiments of the invention shown in FIGS. 1(a) and 1(c).

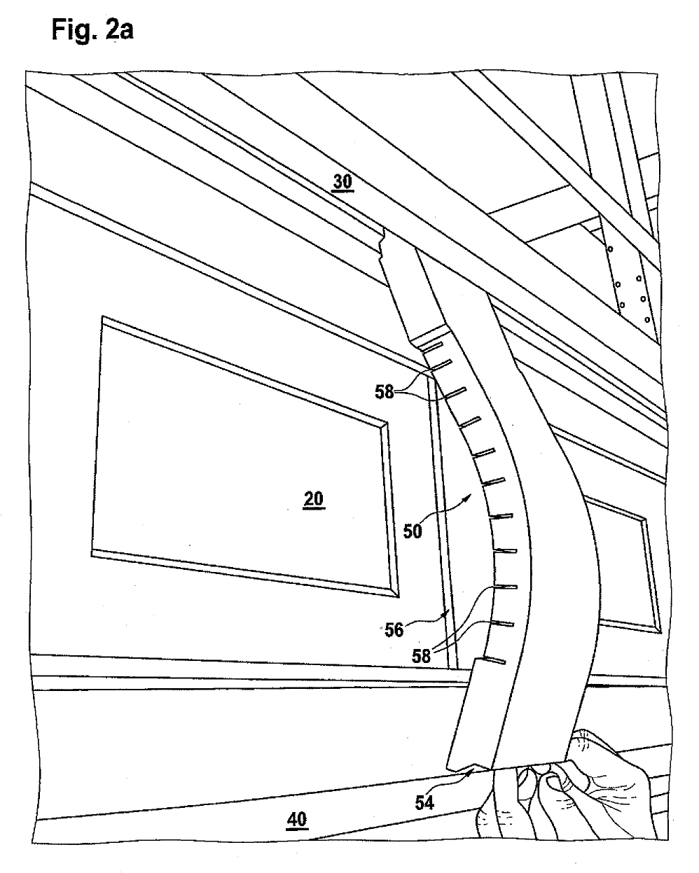

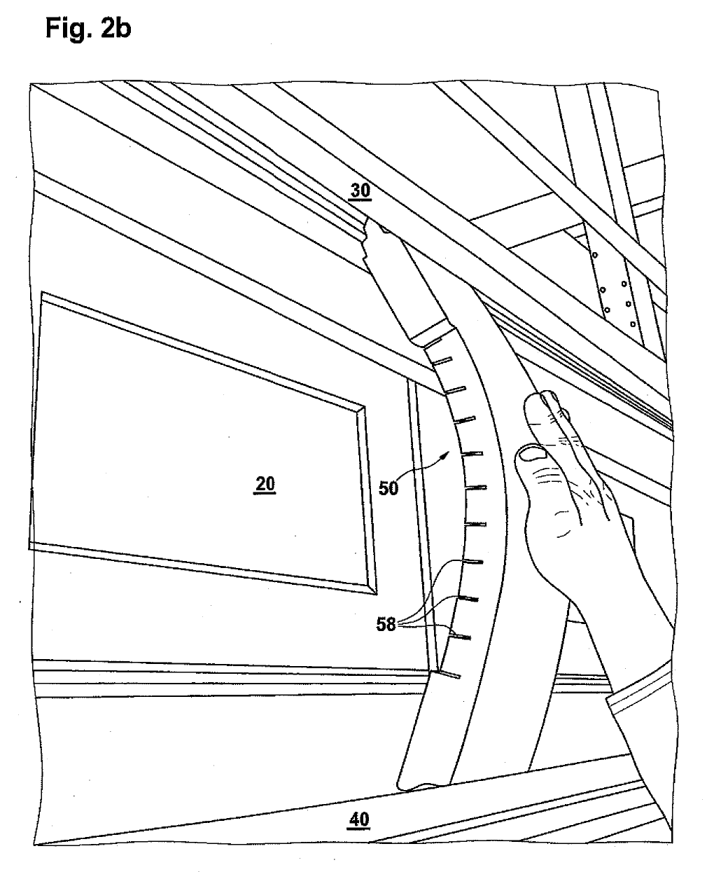

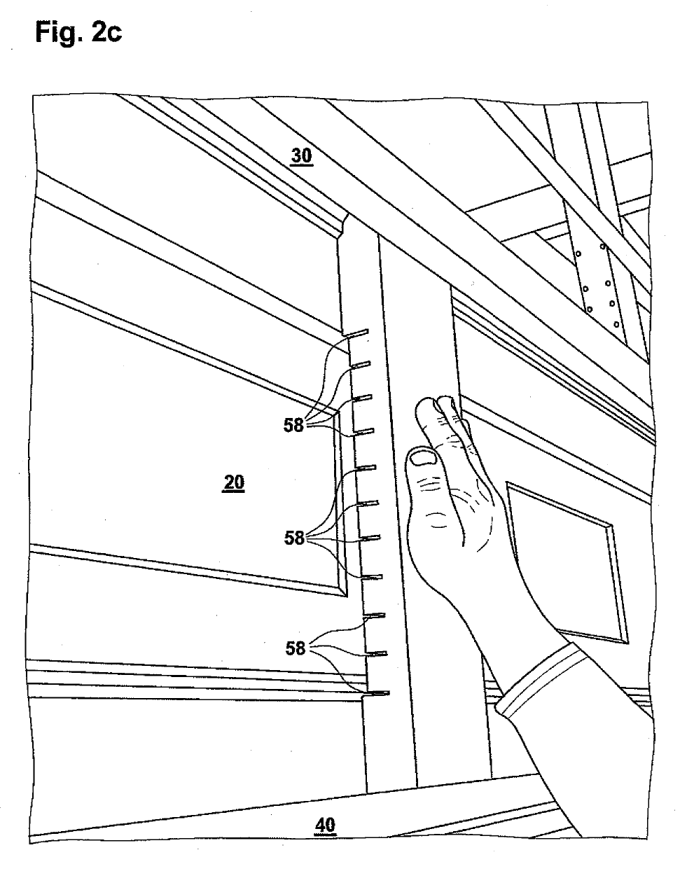

In the embodiments of the invention shown in FIGS. 1(b) and 1(d), the profile is designed in the form of a so-called cassette-profile, as shown also in FIG. 2.

In the embodiment of the invention shown in FIG. 1(b), the insulating element 50 is attached to the shell bottom 20 by means of adhesive strips 28.

In an embodiment, the insulating element 50 exhibits, at its upper edge, a flange 52 capable of being inserted into the protrusion 32 of the shell edge 30, and it exhibits, at its lower edge, an edge profile 54, capable of being inserted into/onto recess 42 at the lower shell edge 40 of the door leaf element.

In the embodiments of the invention shown in FIGS. 1(a) and 1(b), the edge profile 54 extends only over a part of the recess 42 and covers only the front edge of the recess 42. In these embodiments of the invention, the insulating element 50 can have an especially thin design and is pushed against the shell bottom 20 via holding elements 36 or 46 attached to the flanged edges 34 or 44.

In the embodiments of the invention shown in FIGS. 1(c) and 1(d), the edge profile 54 and the entire insulating element 50 extend over the entire thickness of the door leaf element. In this case, the insulating element 50 may be pushed against the shell bottom 20 by means of the flanged edges 34 or 44 of the shell 10, which avoids the use of additional fastening elements.

On the boundary surface of the insulating element 50, facing the shell bottom 20, there is provided a recess, overall designated by 56, to accommodate the beads 22 protruding in the direction of the interior of the space to be closed off with the door leaf, in order to avoid the arching of the insulating element 50 inserted into the door leaf element.

In the area of the recess 56, the insulating element 50 is provided with a multitude of slots 58, extending parallel to the articulating axes and open in the direction of the shell bottom 20, in order to enable the bending of insulating element 50 around a bending axis extending parallel to the articulating axes, while avoiding damage to the insulating element 50. By means of such bending, the insulating element 50 may be introduced into the shell-like door leaf element such that the flange 52 fills out the hollow protrusion 32 of the door leaf element and the recess 42 is accommodated in the edge profile 54 of the insulating element 50, as shown in FIGS. 2a, 2b, and 2c.

In this context, it should be noted that, in the embodiment of the invention shown in FIGS. 2a, 2b, and 2c, the profile of the shell bottom has a cassette-like design and is also accommodated in a recess 56 of the insulating element 50.

Due to the implementation of the weak area, also made apparent in FIGS. 2a, 2b, and 2c, by means of a multitude of slots 58 extending parallel to each other and preferably arranged in equal distances from each other, it is possible to attain a sufficient flexibility of the insulating element 50 while avoiding an excessive local weakening of the insulating element 50 and eliminating the need to combine several materials for the manufacture of the insulating element 50.

In an embodiment of the invention, the edge profile 54 at the lower edge of the insulating element 50 in the form of a semi-notch is realized using only one notched wall. This simplifies the assembly of sectional doors in accordance with the invention. In the event that less importance is attached to simple assembly than to a particularly good insulating effect, the edge profile 54 may also be implemented with two notched walls and a notched bottom, into which the recess 42 can be completely inserted.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A sectional door leaf, comprising:
a single-wall shell, said single-wall shell comprising a shell bottom forming an outer surface of the door leaf and two shell edges protruding from the shell bottom, a first of said two shell edges having a hollow protrusion, and the second of said two shell edges having a recess designed to accommodate a protrusion of an adjacent door leaf; and
an insulating element inserted into the single-wall shell, wherein said insulating element comprises at least one element for cooperation with said hollow protrusion, said recess, or both.

2. The sectional door leaf of claim 1, wherein said single-wall shell design comprises a cold-formed metal shell.

3. The sectional door leaf of claim 1, wherein said two shell edges extend along the entire width of the door leaf.

4. The sectional door leaf of claim 1, wherein said two shell edges extend in the direction of a space to be closed off by the door leaf.

5. The sectional door leaf of claim 1, wherein said hollow protrusion of said first of said two shell edges extends along the entire width of the door leaf.

6. The sectional door leaf of claim 1, wherein said hollow protrusion of said first of said two shell edges extends partially upwards when said door leaf is in a closed position.

7. The sectional door leaf of claim 1, wherein said insulating element comprises an insulating board made of polystyrene.

8. The sectional door leaf of claim 1, wherein said insulating element is removable.

9. The sectional door leaf of claim 1, wherein said at least one element for cooperation with said hollow protrusion, said recess, or both comprises a flange for insertion into and cooperation with said hollow protrusion of said first of said two shell edges.

10. The sectional door leaf of claim 9, wherein said flange extends along the entire width of the insulating element.

11. The sectional door leaf of claim 1, wherein said insulating element further comprises an edge having an edge profile and wherein said at least one element for cooperation with said hollow protrusion, said recess, or both comprises said edge profile, said edge profile being designed to accommodate at least one portion of the recess of the second of said two shell edges.

12. The sectional door leaf of claim 1, wherein said shell bottom has a cassette or beaded profile extending at least partially in the direction of a space to closed off by the door leaf.

13. The sectional door leaf of claim 12, wherein said insulating element has a surface facing the shell bottom and further comprising an insulating element recess in the surface facing the shell bottom, said insulating element recess designed to accommodate said cassette or beaded profile of the shell bottom.

14. The sectional door leaf of claim 13, wherein said insulating element recess extends along the entire width of the insulating element.

15. The sectional door leaf of claim 1, wherein said insulating element has a weak area facilitating bending around a bending axis extending parallel to the width of the insulating element.

16. The sectional door leaf of claim 15, wherein said insulating element has a surface facing the shell bottom and wherein said weak area comprises at least one slot in the surface facing the shell bottom.

17. The sectional door leaf of claim 16, wherein said at least one slot extends into a portion of the thickness of the insulating element in a direction approximately perpendicular to the width of the insulating element.

18. The sectional door leaf of claim 16, wherein said at least one slot comprises a plurality of slots.

19. The sectional door leaf of claim 15, wherein said insulating element has a surface facing the shell bottom and further comprising an insulating element recess in the surface facing the shell bottom, and wherein the weak area is located in the insulating element recess.

20. The sectional door leaf of claim 1, wherein said sectional door leaf is one of a plurality of sectional door leaf elements that are coupled together.

21. An insulating element for use in cooperation with a sectional door leaf having a single-wall shell, said insulating element comprising:
an upper flange for insertion into and cooperation with a hollow protrusion of a first edge of the single-wall shell; and
a lower edge having an edge profile designed to accommodate at least one portion of a recess of a second edge of the single-wall shell.

22. The insulating element of claim 21, wherein said insulating element comprises an insulating board made of polystyrene.

23. The insulating element of claim 21, wherein said upper flange extends along the entire width of the insulating element.

24. The insulating element of claim 21, further comprising an insulating element recess, wherein when said insulating element is in use, said insulating element recess faces the single-wall shell and wherein said insulating element recess is designed to accommodate a profile of the single-wall shell.

25. The insulating element of claim 24, wherein said insulating element recess extends along the entire width of the insulating element.

26. The insulating element of claim 21, further comprising a weak area facilitating bending around a bending axis extending parallel to the width of the insulating element.

27. The insulating element of claim 26, wherein said weak area comprises at least one slot in a surface of said insulating element, wherein, when said insulating element is in use, said surface faces the single-wall shell.

28. The insulating element of claim 27, wherein said at least one slot extends into a portion of the thickness of the insulating element in a direction approximately perpendicular to the width of the insulating element.

29. The insulating element of claim 27, wherein said at least one slot comprises a plurality of slots.

30. The insulating element of claim 26, further comprising an insulating element recess, wherein when said insulating element is in use, said insulating element recess faces the single-wall shell and wherein the weak area is located in the insulating element recess.
